(19) United States
(12) Patent Application Publication
(10) Pub. No.: US 2024/0157442 A1
(43) Pub. Date: May 16, 2024

(54) GAS-PHASE PRODUCTION OF ALIGNED METAL NANOPARTICLES USING EXTERNAL MAGNETIC FIELDS

(71) Applicant: THE REGENTS OF THE UNIVERSITY OF CALIFORNIA, Oakland, CA (US)

(72) Inventors: Michael R. Zachariah, Riverside, CA (US); Reza Abbaschian, Riverside, CA (US); Pankaj Ghildiyal, Riverside, CA (US); Steven Herrera, Riverside, CA (US); Prithwish Biswas, Riverside, CA (US)

(73) Assignee: THE REGENTS OF THE UNIVERSITY OF CALIFORNIA, Oakland, CA (US)

(21) Appl. No.: 18/549,634

(22) PCT Filed: Mar. 9, 2022
(86) PCT No.: PCT/US2022/019539

§ 371 Date: Sep. 8, 2023

Related U.S. Application Data
(60) Provisional application No. 63/158,981, filed on Mar. 10, 2021.

(51) Int. Cl. B22F 9/12; B22F 1/054; B22F 1/142; B82Y 25/00; H01F 1/00

(52) U.S. Cl. CPC B22F 9/12; B22F 1/054; B22F 1/142; B82Y 25/00; H01F 1/0045; B22F 2202/01; B22F 2202/05; B22F 2202/07

(57) ABSTRACT

A method and system are disclosed of assembling metal particles into nanoparticles. The method includes electromagnetically levitating the metal particles; inductively heating the electromagnetically levitated metal particles beyond their melting point into metal droplets; and wherein an evaporation flux achieved at a surface of the metal droplets result in a supersaturation of metal atoms around the metal droplets leading to nucleation and growth of the nanoparticles.

### CROSS REFERENCE TO RELATED APPLICATIONS

This application claims the benefit of U.S. Provisional Application 63/158,981, filed Mar. 10, 2021, which is incorporated by reference in its entirety.

### GOVERNMENT CLAUSE

This invention was made with government support under grant number N00014-21-1-2038 awarded by the Office of Naval Research (ONR). The government has certain rights in this invention.

### TECHNICAL FIELD

The present disclosure generally relates to a method and system of assembling metal particles into nanoparticles.

### BACKGROUND

Metal nanoparticles and their assemblies are being explored as functional components in sensors, plasmonics, energetic composites, electronics, and catalytic materials. Demands for devices and composites based on metal nanoparticle systems have fostered the development of scalable synthetic approaches that can assemble metal nanoparticles into well-defined structures and arrangements. The structure and arrangement of metal nanoparticles in organized assemblies show collective properties that depend on size, shape, and surface properties of aggregates having applications in imaging, sensing, and photocatalysis. These properties are also the deciding factors in modulation of material properties such as packing density, porosity, and mechanical strength in composite structural materials such as aerogels. Aligned nanoparticle chains have high aspect ratios and high surface area-volume ratio characteristics that have shown to have important applications in surface-sensitive applications such as catalysis and sensors. Therefore, particle production techniques that are scalable and capable of morphological control of aggregate architecture and arrangement are highly desirable. Currently, controlled assembly has been limited to traditional colloidal phase routes that employ surface capping to stabilize metal nanoparticles and prevent irreversible, random aggregation. These stabilized primary particles can be used as building blocks to engineer the formation of complex aggregates with desired architecture in a stepwise manner. However, such multi-step control is impossible in high purity gas-phase synthesis as the particles aggregate instantaneously after nucleation and formation of primary particles. As a result, while directed assembly of particles is common in colloidal chemistry, it has rarely been explored in aerosol-based synthesis. In addition, solution phase syntheses use multi-step processes that involve ligands, surfactants, and hazardous solvents, that require additional purification steps, thereby limiting their scalability.

In this regard, gas-phase synthesis approaches are particularly attractive as they not only allow for continuous particle production but also circumvent the need for surfactants or ligands, thus enabling direct, scalable production of high purity metal nanoparticles. However, a major limitation of gas-phase synthesis is the associated difficulty in directing the assembly of metal nanoparticles in a controlled manner, as Brownian forces cause random aggregation. As a result, commercially available nanoparticles generated by gas-phase synthesis such as laser ablation and sputtering are randomly aggregated without any well-defined microstructural features.

Levitation-flow technique is an alternative gas-phase technique for metal nanoparticle synthesis, however, so far particle characterization has been mostly limited to synthesis and bulk-characterization of nanoparticles, while the control on aggregate architecture and controlled assembly have been vastly neglected.

### SUMMARY

In accordance with an exemplary embodiment, a method is disclosed of assembling metal particles into nanoparticles, the method comprising: electromagnetically levitating the metal particles; inductively heating the electromagnetically levitated metal particles beyond their melting point into metal droplets; and wherein an evaporation flux achieved at a surface of the metal droplets result in a supersaturation of metal atoms around the metal droplets leading to nucleation and growth of the nanoparticles.

In accordance with another exemplary embodiment, a system is disclosed for assembling metal particles into nanoparticles, the system comprising: an electromagnetic levitation coil, the electromagnetic levitation coil configured to electromagnetically levitate the metal particles and inductively heat the electromagnetically levitated metal particles beyond their melting point into metal droplets; and wherein an evaporation flux achieved at a surface of the metal droplets result in a supersaturation of metal atoms around the metal droplets leading to nucleation and growth of the nanoparticles.

### BRIEF DESCRIPTION OF THE DRAWINGS

FIG. 1 is a schematic illustration showing on-the-fly formation and directed assembly of metal nanoparticles from electromagnetically levitated metal droplets, and wherein different aggregate structures, for example, stringy chain-like and compact assemblies are accessible.

FIG. 2a is a schematic showing on-the-fly generation of metal nanoparticles and aggregate assemblies from electromagnetically levitated metal droplets, and FIG. 2b is a schematic showing levitated Fe piece heated at 1750K (˜m. p. Fe=1811K) assumes a spherical droplet shape.

FIG. 3 is X-Ray Diffraction patterns for Fe, Cu, and Ni nanoparticles collected from the levitated droplet system at droplet temperatures of Fe (2073K), Ni (1990K), and Cu (1990K).

FIG. 4 illustrates typical aggregates and their corresponding fractal dimensions (Df) for Fe, Ni, and Cu obtained from their respective metal droplets at 1940K, 1900K, and 1640K, respectively (scale bar: 100 nm), and wherein Fe and Ni nanoparticles tend to form string-like aggregates with lower Df than that for Cu.

FIG. 5a is a schematic illustration of a levitated metal droplet in the magnetic field arising from the levitation coils, and FIG. 5b is a chart illustrating an estimated H-field interaction parameter, m, as a function of distance along coil-axis (z-axis) for different peak magnetic field strengths of the levitation coils, and wherein m=200 k_{B}T₀ represents the transition from Brownian coagulation to magnetic-field interaction-dominated aggregation.

FIG. 6 is a schematic illustration of levitated metal droplet arising from the levitation coils in accordance with an exemplary embodiment.

FIGS. 7a-7b are SEM images of aggregates deposited directly on carbon substrate from levitated droplets of FIG. 7a Fe (2000K), and FIG. 7b Cu (1640K). Fe aggregates show an open, porous morphology, while Cu aggregates appear compact. Scale bars: FIG. 7a 2 μm (top), 200 nm (bottom), and FIG. 7b 2 μm (top), 200 nm (bottom).

FIG. 8 is a schematic of inductively heated metals in a horizontal evaporation system, resulting in particle formation with a coil-induced magnetic field in accordance with an exemplary embodiment.

### DETAILED DESCRIPTION

In accordance with an exemplary embodiment, an electromagnetic levitation technique is disclosed, which uses magnetic fields to levitate and inductively heat metal pieces, that result in metal evaporation and formation of nanoparticles in the gas phase. In addition, the applied field has an additional aligning effect, for example, on ferromagnetic metals, such as Fe and Ni. For Fe and Ni, the magnetic field interacts with the generated particles to form chain assemblies, for example, composed of less than 20 nm particles, which effect has not been observed for non-ferromagnetic materials. Thus, employing an external magnetic field during particle formation leads to controlled formation of chain aggregates with a relatively high aspect-ratio and surface area.

In accordance with an exemplary embodiment, since the process is a continuous, gas-phase technique, the process can be scaled up and nanochains can be produced in a scalable manner. In addition, bulk powders can be generated, which retain their chainlike morphology, which can allow for the commercial manufacturing of nanopowders composed of high surface-area metal nanochains, and which materials can be used in optoelectronics, biomedical imaging, sensing, catalysis, and as filtration and purification materials.

### Features of Electromagnetic Levitation Synthesis:

Gas-phase synthesis techniques offer a scalable approach to production of metal nanoparticles, however, directed assembly has been challenging due to fast particle diffusion rates that lead to random Brownian aggregation. In accordance with an exemplary embodiment, a method and system are disclosed that allows for directionality and control of nanoparticle assembly in the gas phase, which can be achieved by employing an external magnetic field from the levitation coils during particle formation such that directional interactions with the H-field compete with random particle aggregation.

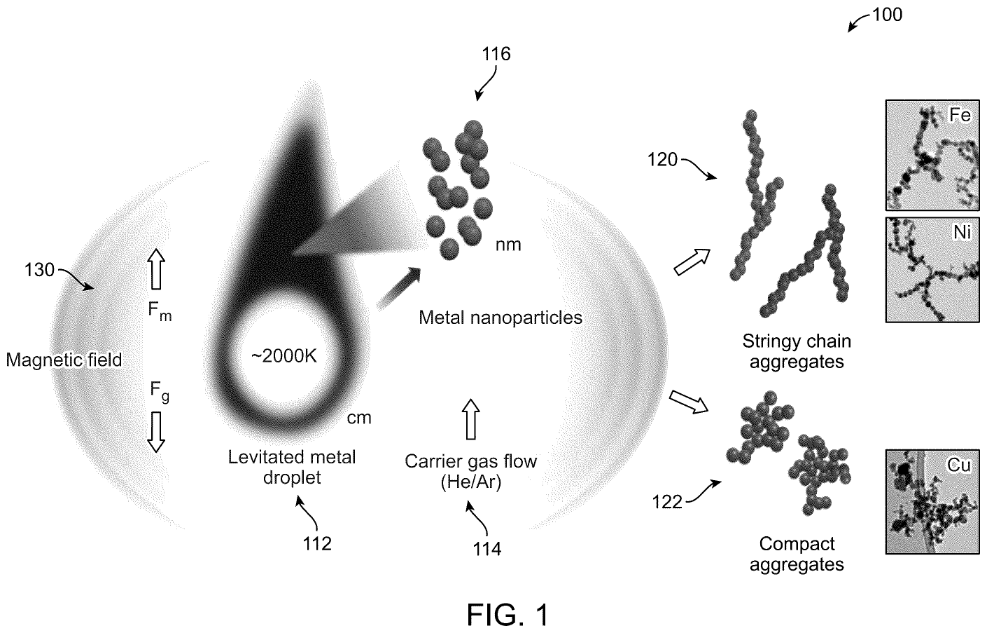

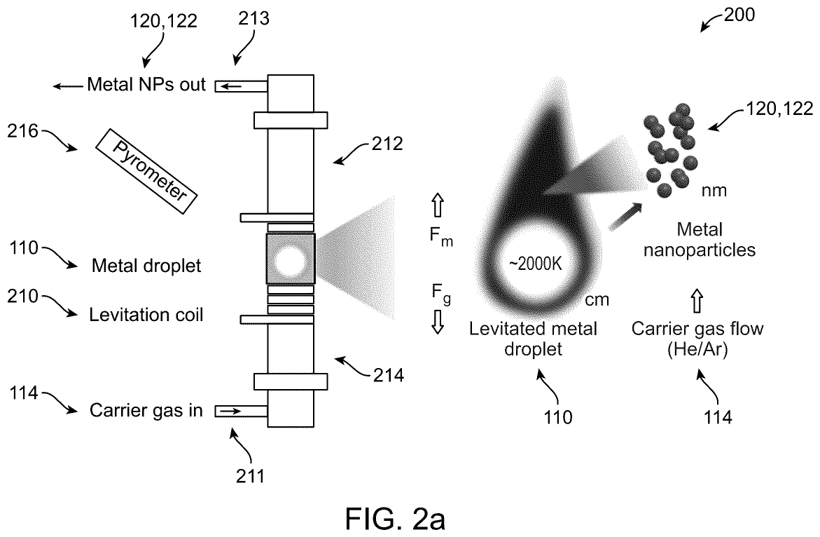

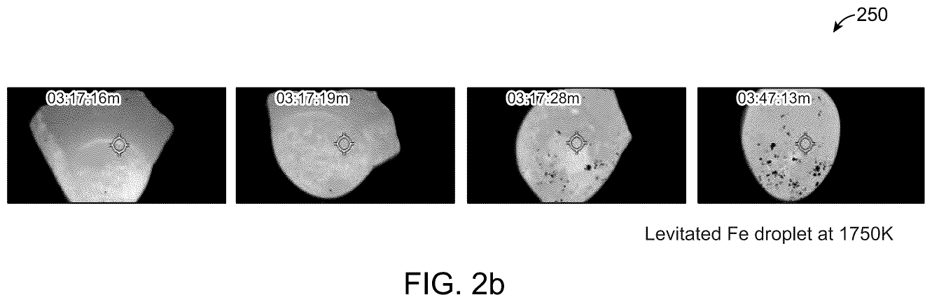

In accordance with an exemplary embodiment, an electromagnetic-levitation technique is disclosed in which the particle formation occurs in the presence of a relatively strong magnetic field. In addition to levitation and induction heating, the external magnetic field can be applied to compete with random Brownian forces, which enables the formation of stringy, chain structures as shown in FIGS. 1, 2a, and 2b. As shown in FIG. 1, the ferromagnetic metals (Fe, Ni) form chain-like aggregates 120, while Cu forms compact nanoparticle aggregates 122. In accordance with an exemplary embodiment, a method and system for selective, on-the-fly, gas-phase assembly of particles with morphologically different microstructural features is disclosed. In addition, the process is solvent and ligand-free, continuous, and allows for gas-phase fabrication of high-purity metal nanoparticles with tunable micro-structural features, thus opening various possibilities for density, mechanical, and optical property modulation in the final materials of interest.

### Details of the System:

FIG. 2a shows an illustrative system 200 for electromagnetic levitation and heating of metal droplets 110 (FIG. 1) to generate metal nanoparticles 120, 122 in accordance with an exemplary embodiment. As shown in FIG. 2a, the system 200 includes a levitation coil 210 wrapped around a tubular member 212. The tubular member 212 having an inlet 211 and an outlet 213, and wherein the inlet 211 is configured to receive a carrier gas 114. The tubular member 212 can be, for example, a quartz tube 214. The system 200 can also include a pyrometer 216, for example, a two-color pyrometer, which is configured to monitor a surface temperature of the heated metal droplets 110 within the levitation coil 210. The metal nanoparticles 120, 122 exit the tubular member 212 via the outlet 213.

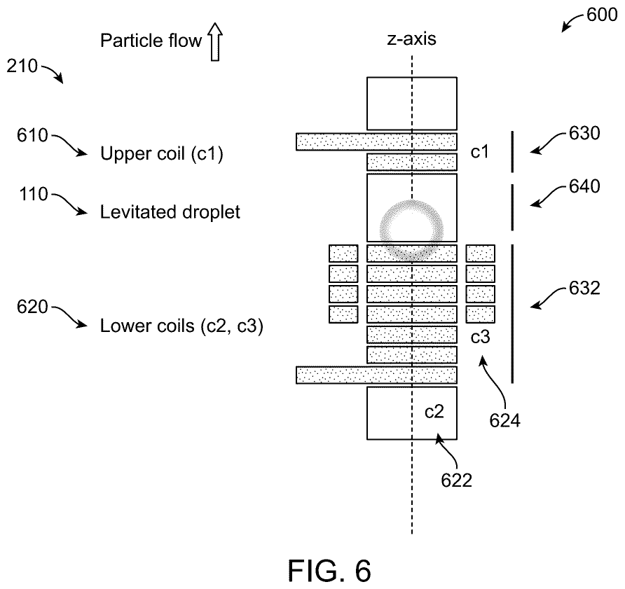

In accordance with an exemplary embodiment, the system 200 is used to superheat the metal droplets 110 around the melting points of the metal droplets 110. The levitation coil 210, for example, can be made from copper tubing. In accordance with exemplary embodiment, the copper tubing, for example, has an outer diameter (O.D.) of approximately ⅛″ with a wall thickness of 1/32″, and insulated, for example, with fiberglass tape. The levitation coil 210 is made to fit around the tubular member 212 (i.e., quartz tube 214). The quartz tube 214 can have, for example, an outer diameter (O.D.) of approximately ⅝″ and the levitation coil 210 is tightly wound around the quartz tube 214. For example, the levitation coil 210 can include 11 turns creating a field in an upward direction and 2 turns creating a field in a downward direction as further described in connection with FIG. 6. In accordance with an embodiment, a 10 mm gap between the arranged between the 11 turns and the 2 turns, which separates the fields in the upward and the downward directions. The levitation coil 210 can be water cooled and powered, for example, by a 20-kW high frequency (8 MHz) generator.

In accordance with an embodiment, a titanium getter, heated at 800° C., can be employed to purify the carrier gas 114. The carrier gas 114, for example, can be He and Ar. The carrier gas 114 preferably has a purity of approximately 99.999% to help prevent oxidation of the superheated metal droplets 220. The carrier gas 114 is then fed through the quartz tube 216 to carry the metal nanoparticles 120, 122 through the tubular member 212 for collection at the outlet 213 of the tubular member 212. In addition, a type of carrier gas 114 can be selected to help control the temperature of the metal droplets 220 within the levitation coil, and corresponding characterizations of the nanoparticles 120, 122.

In accordance with an exemplary embodiment, metal pieces, for example, bulk metal pieces can be cut and weighed according to the desired diameter of the metal droplet 110 suitable for the quarts tube 216 (e.g., a glass tube) housing in the levitating system 200. In accordance with an embodiment, droplet diameters, for example, can be approximately 6 mm to 10 mm, with their corresponding mass of the metal pieces being approximately 2.58 g (Cu, Ni) and approximately 2.47 g (Fe). In accordance with an embodiment, the metal pieces can be ultrasonicated in acetone, for example, for approximately 15 minutes to remove surface impurities.

In accordance with an exemplary embodiment, the metal pieces are then introduced into the tubular member 212 with the levitation coil 212, where the metal pieces are levitated and heated to temperatures beyond their melting point. For example, as shown in FIG. 2b, the metal pieces 250 at temperatures in excess or beyond their melting point will assume a spherical shape due to surface tension. Fe droplets can assume a spherical shape at approximately 1750 K.

In accordance with an exemplary embodiment, the droplet temperature can be modulated by varying the field strength of the levitation coils and based on the type of the carrier gas 114 (for example, He or Ar), and wherein the carrier gases 114 also function as a cooling gas. In addition, the carrier gas 114 is preferably maintained at a relatively constant flow around the metal droplet 110. A pyrometer 216, for example, a two-color pyrometer can continuously monitor the surface temperature of the heated droplets 110. The pyrometer 216 can be calibrated by levitation-heating and cooling of standard metal pieces (Cu, Mn, Fe, Ni, and Ti), and using the recalescence point at the known melting points of the metal pieces.

FIG. 3 shows the X-Ray diffraction patterns 300 of the nanoparticles 120, 122, for example, metal powders collected from the levitation system 200 showing that the nanoparticles 120, 122, emanating from the levitated droplets 110 are in a metallic phase.

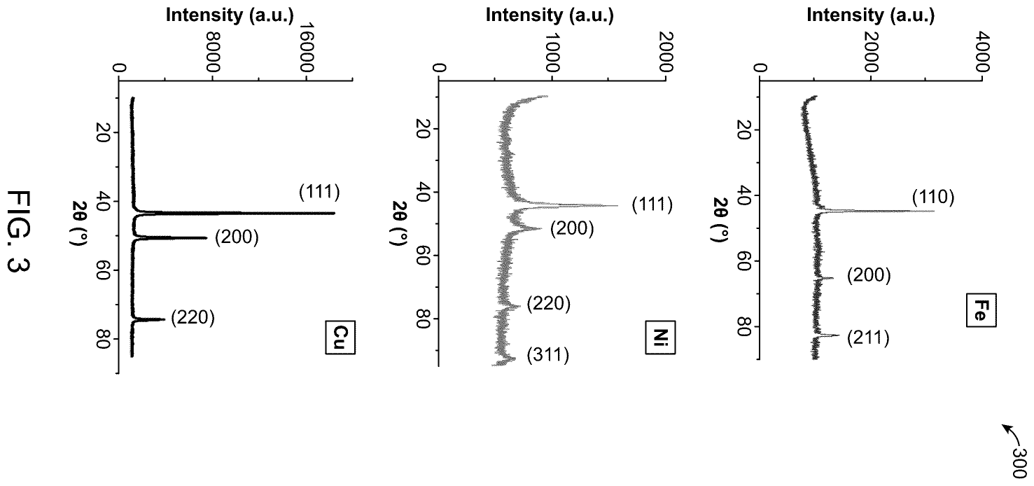

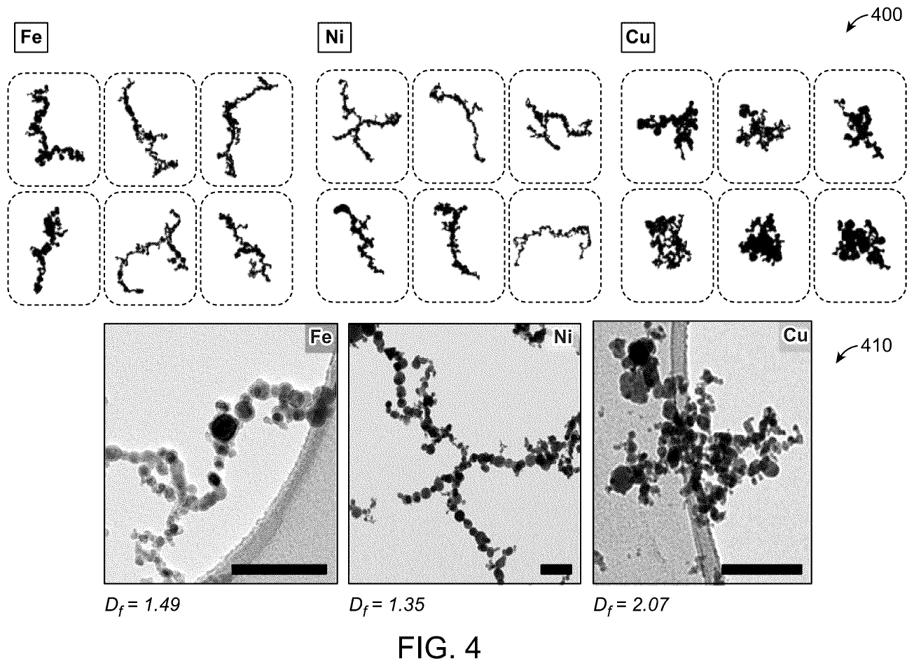

FIG. 4 illustrates typical aggregates 400 and their corresponding fractal dimensions 410 (Df) for Fe, Ni, and Cu obtained from their respective metal droplets at 1940K, 1900K, and 1640K, respectively (scale bar: 100 nm), and wherein Fe and Ni nanoparticles 120 tend to form string-like aggregates with lower Df than that for the Cu nanoparticles 122.

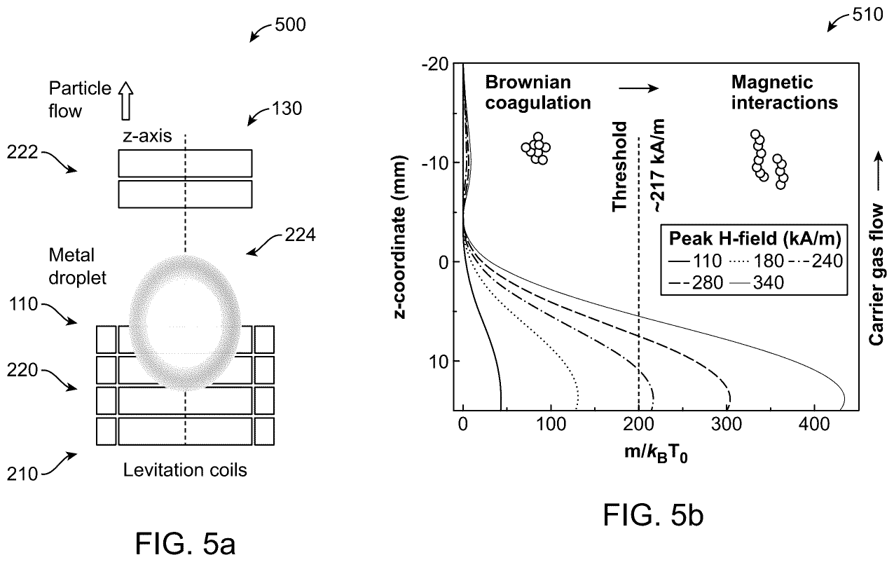

FIG. 5a is a schematic illustration 500 of a levitated metal droplet 110 in the magnetic field 130 arising from the levitation coils 120. As shown in FIG. 5a, the levitation coils 210 include a plurality of coils 220, for example, 11 turns creating a magnetic field in an upward direction, and a number of turns 222, for example, 2 turns creating a field in a downward direction. In accordance with an embodiment a gap 224, for example, 10 mm, separates the upward direction and the downward direction.

FIG. 5b is a chart 510 illustrating an estimated H-field interaction parameter, m, as a function of distance along coil-axis (z-axis) for different peak magnetic field strengths of the levitation coils, and wherein m=200 k_{B}T₀ represents the transition from Brownian coagulation to magnetic-field interaction-dominated aggregation. Results from a Monte-Carlo simulation suggests a minimum value of magnetic field strength of approximately 217 kA/m for aligned aggregates to be formed, as shown in FIG. 5b. The magnetic field strengths, for example, as shown in FIG. 5b, ranges from approximately 110 kA/m to 340 kA/m. Therefore, interparticle forces can be induced by the high external magnetic field employed in the levitation system 200, which are sufficient to compete with Brownian diffusion forces, resulting in elongated chain aggregates values for Fe and Ni, as disclosed. As shown in FIG. 6, the levitation system 600 can consist of two sets of coaxial coils carrying currents with a 180-degree phase difference, resulting in magnetic fields along the coil z-axis in opposite directions. The upper coil 610 (c1) may be composed of a single coil (e.g., 2-turns) and generates a magnetic field in the downward direction 630 (towards gravity). The lower coil 620 may be composed of two coaxial coils 622, 624 (e.g., c2-7 turns and c3-4 turns, respectively) and creates a field in the upward direction 632 (against gravity). By convention, the field in the upward z-direction is depicted as positive. The upper coil 610 and the lower coil 620 can be separated by a gap 640, for example, a 10 mm gap. In order to achieve relatively high temperatures, the droplet 110 is levitated closer to the lower coil 620 than the upper coil 610 as shown.

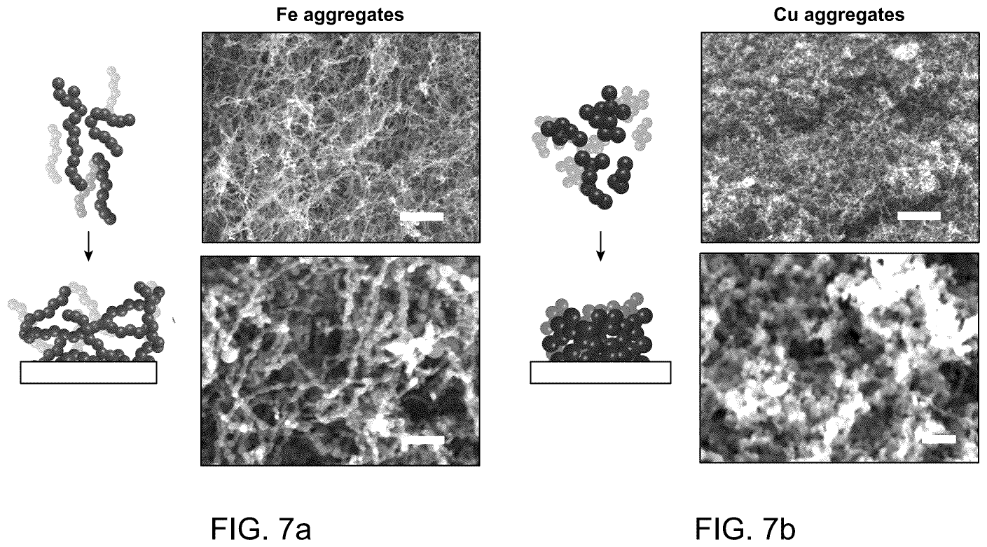

FIGS. 7a-7b shows SEM images 700, 710 of two kinds of morphologically distinct materials generated from levitated metal droplets of Fe and Cu. As disclosed, due to the chainlike and elongated morphology of Fe aggregates induced by the magnetic field, the material deposited from Fe droplets also exhibit an open and porous structure, while the structure for copper appears rather compact and dense. In other words, the morphological features of the aggregates are mirrored in the bulk powder material at the micron-scale as well.

In accordance with an embodiment, the production rate of Fe nanochain aggregate powders can be estimated, for as follows. For example, for a 6 mm diameter droplet levitated at 2000° C., the mass of nanopowder collected can be approximately 110 mg/h. For a larger droplet, for example, a droplet having approximately 60 mm diameter in a commercial reactor, mass evaporation and production rate would scale according to the surface area be approximately 11 g/h. Assuming typical power consumption including electricity and a production time, a significant reduction in production times and manufacturing costs can be obtained.

Traditional colloidal techniques for synthesis of assembled nanoparticles use multi-step processes involving hazardous solvents and surfactants that require additional purification steps. The presented electromagnetic levitation system 200, on the other hand, is single step, continuous, avoids use of hazardous solvents, and generates assemblies of high purity nanometals that are ligand or surfactant free. Thus, these characteristics make this technique for particle assembly more scalable and facile to generate large quantities of metal particle chain assemblies.

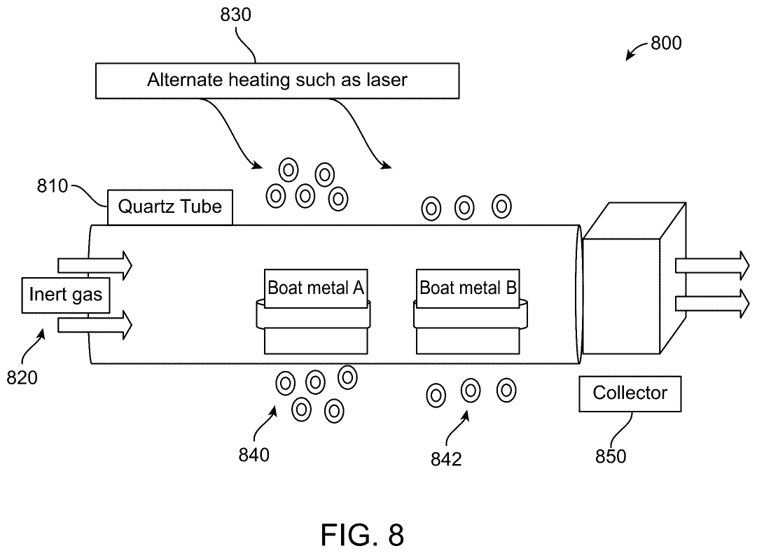

In accordance with an embodiment, a magnetic field can be applied during particle formation to form chain structures in other gas phase synthesis methods, such as horizontal evaporation process 800 as shown in FIG. 8. As shown in FIG. 8, the horizontal evaporation process 800 can include a tubular member 810, for example, a quartz tube, a carrier gas 820, a heating source 830, induction coils 840, 842, and a collector 850. The carrier gas 820 is preferably an inert gas, for example, He or Ar. The heating source 830 can be, for example, a laser. In accordance with an exemplary embodiment, the induction coils 840, 842, can provide both heating and an alignment field. In accordance with an alternative embodiment, the heating can be provided or augmented by other sources, such as lasers, followed by magnetic field for alignment, which can enable non-metallic vaporization.

1. A method of assembling metal particles into nanoparticles, the method comprising:
electromagnetically levitating the metal particles;
inductively heating the electromagnetically levitated metal particles beyond their melting point into metal droplets; and
wherein an evaporation flux achieved at a surface of the metal droplets result in a supersaturation of metal atoms around the metal droplets leading to nucleation and growth of the nanoparticles.

2. The method according to claim 1, wherein the electromagnetically levitated metal particles are inductively heated in an electromagnetic levitation coil arranged around a tubular member, the method further comprising:
injecting a carrier gas into one end of the tubular member; and
transporting the nanoparticles with the carrier gas to an other end of the tubular member.

3. The method according to claim 2, further comprising:
employing an external magnetic field from the levitation coil during particle formation such that directional interactions of a magnetic H-field compete with random particle aggregation.

4. The method according to claim 1, wherein the metal particles are Cu, Mn, Fe, Ni, or Ti.

5. The method according to claim 1, wherein the carrier gas is He or Ar.

6. The method according to claim 1, further comprising:
heating the metal particles up to 2500K.

7. The method according to claim 1, wherein the metal particles are heated to 1640K to 1940K.

8. The method according to claim 1, further comprising:
removing surface impurities on the metal particles by ultra-sonication in acetone.

9. The method according to claim 1, wherein the metal droplets have a spherical shape.

10. The method according to claim 1, wherein the metal particle are electromagnetically levitated at an electromagnetic field strength of 110 kA/m to 340 kA/m.

11. The method according to claim 2, further comprising:
modulating a droplet temperature of the metal particles by varying a field strength of the levitation coils;
selecting a type of the carrier gas to further control the droplet temperature; and
maintaining a constant flow of the carrier around the metal droplet.

12. (canceled)

13. (canceled)

14. The method according to claim 1, further comprising:
monitoring a surface temperature of the heated droplets with a pyrometer.

15. The method according to claim 14, further comprising:
calibrating the pyrometer using a recalescence point at a known melting point of the metal particles.

16. A system for assembling metal particles into nanoparticles, the system comprising:
an electromagnetic levitation coil, the electromagnetic levitation coil configured to electromagnetically levitate the metal particles and inductively heat the electromagnetically levitated metal particles beyond their melting point into metal droplets; and
wherein an evaporation flux achieved at a surface of the metal droplets result in a supersaturation of metal atoms around the metal droplets leading to nucleation and growth of the nanoparticles.

17. The system according to claim 16, wherein the electromagnetically levitated metal particles are inductively heated in the levitation coil, which is arranged around a quartz tube.

18. The system according to claim 17, further comprising:
a carrier gas configured to be injected into one end of the quartz tube and to transport the nanoparticles to an other end of the quartz tube.

19. The system according to claim 16, further comprising:
the metal particles, the metal particles being Cu, Mn, Fe, Ni, or Ti particles; and
wherein the carrier gas is He or Ar.

20. The system according to claim 16, wherein the electromagnetic levitation coil comprises:
two sets of coaxial coils configured to carry a current with a 180-degree phase difference, which results in magnetic fields along the levitation coil in opposite directions, the two sets of coaxial coils including an upper coil configured to generate a magnetic field in a downward direction and a lower coil configured to create a magnetic field in an upward direction; and
wherein the two sets of coaxial coils are separated by a gap, and the upper coil comprises a 2-turn coil configured to generate the magnetic field in the downward direction and the lower coil comprising an 11-turn coil composed of two coaxial coils, one of the two coaxial coils comprising 7 turns and an other of the two coaxial coils comprising 4 turns, the two coaxial coils configured to create the magnetic field in the upward direction.

21. (canceled)

22. The system according to claim 16, wherein the levitation coil is configured to be inductively heat the metal particles up to 2500K, and the metal particle are electromagnetically levitated at an electromagnetic field strength of 110 kA/m to 310 kA/m.

23. The system according to claim 16, further comprising:
a pyrometer configured to monitor a surface temperature of the heated droplets.
